(19) United States
(12) Patent Application Publication
(10) Pub. No.: US 2009/0086029 A1
(43) Pub. Date: Apr. 2, 2009

(54) Method of transmitting real-time network image

(75) Inventors: Huan-Yun Wei, Taipei City (TW); You-Hsin Yen, Taipei City (TW); Yi-Hsiang Lin, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 11/979,392

(22) Filed: Nov. 2, 2007

(30) Foreign Application Priority Data
Sep. 28, 2007 (TW) 096136149

(51) Int. Cl. H04N 5/225

(52) U.S. Cl. 348/207.1

(57) ABSTRACT

A method of transmitting a real-time network image is applied to a network system having an IP camera, a NAT router, the Internet, and a server of an Internet service provider (ISP). The method includes steps of: requesting an IP address from the DHCP server by the IP camera according to a DHCP protocol when the IP camera is linked to the Internet via the NAT router; automatically logging the IP camera in the ISP server after requesting the IP address and linking to the Internet; and building up a linking channel between the IP camera and the ISP server after finishing logging. As a result, other remote electronic devices can download a real-time image captured by the IP camera through the linking channel via the Internet after logging in the ISP server.

### FIELD OF THE INVENTION

The present invention relates to an IP, and more particularly to a method of transmitting a real-time network image capable of installing and operating an IP camera easily, without executing any setting, for transmitting a real-time image to other remote electronic device via the Internet.

### BACKGROUND OF THE INVENTION

Recently, an IP camera (i.e. Internet Protocol camera) which is a device having a video image capturing function is developed. The operation principle of the IP camera is to capture a video image of a scene by a lens, and then process the video image by an optical sensor and a controller in the IP camera, so as to convert the video image into a digital signal which can be recognized by a computer. Furthermore, other remote electronic device can also show a real-time image captured by the IP camera via certain application software or browser.

Presently, due to the advances of digital photographic technologies and network communication technologies, the price of the IP camera is increasingly lowered, while the product resolution and performance thereof are increasingly enhanced. Thus, the IP camera is applied to various security software, video conference software, video chat-room software, game software, and etc., while the combination of the IP camera and the software is widely applied to the daily life and the working of humans. Nowadays, millions of IP cameras are installed on world-wide houses, offices, downtown streets, and countries for transmitting real-time images therefrom. Even, many IP cameras are applied to security monitoring of public places, traffic flow managements, and monitoring researches of weather and volcano activities.

Traditionally, for a commercially-available IP camera, if a user wants to link the IP camera to the Internet via a NAT router (i.e. Network Address Translation router) for sharing a real-time image captured by the IP camera with a remote electronic device, the NAT router must be suitably set to carry out an address translation setting. In this manner, a public network address and a port of the remote electronic device which are linked to the NAT router will be further translated by the NAT router and then transmitted to the IP camera. As described above, when the traditional IP camera transmits the captured real-time image to the remote electronic device via the NAT router and the Internet, the function of sharing the real-time image with the remote electronic device can not be carried out unless a plurality of complicated linking processes and setting procedures are firstly processed. However, it wastes too much time and effort. Meanwhile, in consideration of professionally complicated linking processes and setting procedures, most of users generally don't like to fully use the function of transmitting real-time image provided by the IP camera. As a result, it is important for related manufacturers to think how to develop a method of transmitting a real-time network image, in order to substantially reduce the time and the difficulty of linking an IP camera and a remote electronic device, for the purpose of urging users to use the function of transmitting the real-time image provided by the IP camera.

It is therefore tried by the inventor to develop a method of transmitting a real-time network image to solve the foregoing problems of complicated linking processes and setting procedures when linking the traditional IP camera and the remote electronic device, so that a user can easily operate the IP camera to transmit a real-time image to other remote electronic device via the Internet without executing any setting.

### SUMMARY OF THE INVENTION

A primary object of the present invention is to provide a method of transmitting a real-time network image, which is applied to a network system comprising an IP camera (i.e. Internet Protocol camera), a NAT router (i.e. Network Address Translation router), the Internet, and a server of an Internet service provider (ISP), wherein the NAT router and the ISP server are linked to the Internet, respectively, while the NAT router is provided with a DHCP server (i.e. Dynamic Host Configuration Protocol server). The method comprises the steps of: requesting an IP address from the DHCP server by the IP camera according to a DHCP (Dynamic Host Configuration Protocol) when the IP camera is linked to the Internet via the NAT router; automatically logging the IP camera in the ISP server after requesting the IP address and linking to the Internet; and building up a linking channel between the IP camera and the ISP server after logging in. As a result, other remote electronic device (such as personal computer, PDA, and etc.) can download a real-time image captured by the IP camera through the linking channel via the Internet after logging in the ISP server.

A secondary object of the present invention is to provide a method of transmitting a real-time network image, wherein a user can easily install and operate an IP camera without executing any setting, only if connecting the IP camera to an NAT router. As a result, the purpose of transmitting a real-time image to other remote electronic device via the Internet will be carried out.

A third object of the present invention is to provide a method of transmitting a real-time network image, wherein other remote electronic device can directly use a linking channel previously built-up between an IP camera and a server of an Internet service provider (ISP) after the remote electronic device logs in the ISP server, so as to prevent from passing through a firewall set by a NAT router for the purpose of smoothly downloading a real-time image captured by the IP camera.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic view of a network built-up between an IP camera, a NAT router, and the Internet according to a preferred embodiment of the present invention;

FIG. 2 is a flowchart of a method of transmitting a real-time network image according to a preferred embodiment of the present invention; and

FIG. 3 is a schematic view of a network built-up between an IP camera, a personal computer, a NAT router, and the Internet according to another preferred embodiment of the present invention.

### DETAILED DESCRIPTION OF THE PREFERRED EMBODIMENTS

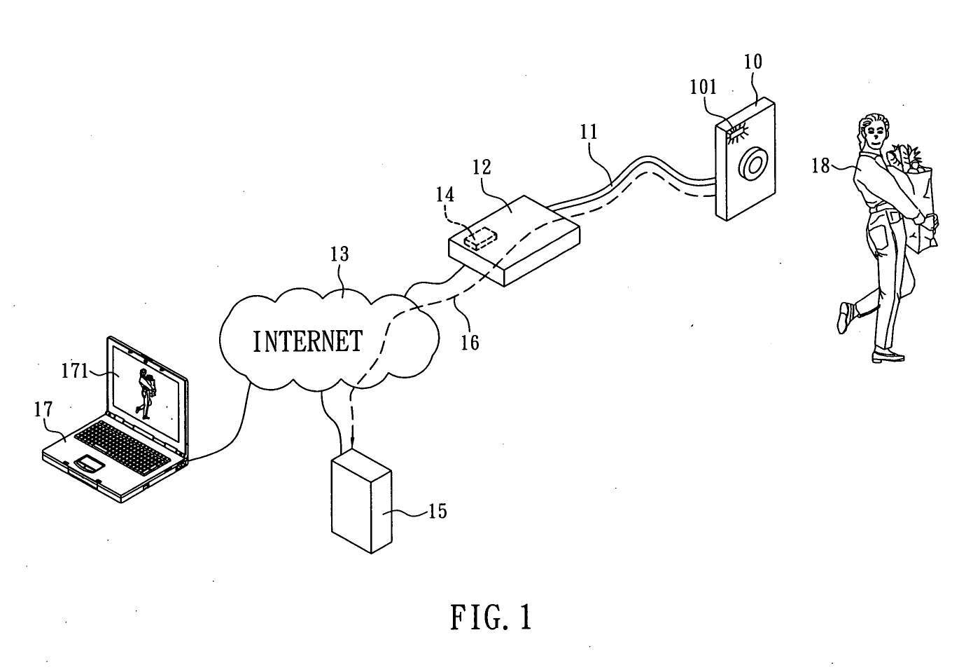

Referring FIG. 1, a method of transmitting a real-time network image according to a preferred embodiment of the present invention is illustrated. As shown, the method is applied to a network system comprising an IP camera 10, a NAT router 12, the Internet 13, and a server 15 of an Internet service provider (ISP). The IP camera 10 is connected to the NAT router 12 via a signal cable 11, such as a USB cable. The NAT router 12 is connected to the Internet 13, and provided with a DHCP server 14 therein. When the IP camera 10 is linked to the Internet 13 via the NAT router 12, the IP camera 10 directly requests an IP address from the DHCP server 14 of the NAT router 12 according to a DHCP (Dynamic Host Configuration Protocol). After requesting the IP address and linking to the Internet 13, the IP camera 10 can automatically log in the ISP server 15 linked to the Internet 13. After finishing logging, a linking channel 16 between the IP camera 10 and the ISP server 15 will be built up. As a result, other remote electronic devices 17 (such as personal computer, PDA, and etc.) can download a real-time image captured by the IP camera 10 through the linking channel 16 via the Internet 13 after logging in the ISP server 15. Then, the remote electronic device 17 can show the real-time image on a display 171 formed thereon. As described above, the design principle of the present invention is to actively linking the IP camera 10 in a private network to the ISP server 15 in a public network, so that the remote electronic device 17 outside the public network can be firstly linked to the ISP server 15 and then indirectly linked to the IP camera 10 in the private network via the linking channel 16 previously built-up by the IP camera 10 in a inside-out manner. As a result, it will be unnecessary for a user to execute complicated setting procedures to the NAT router 12.

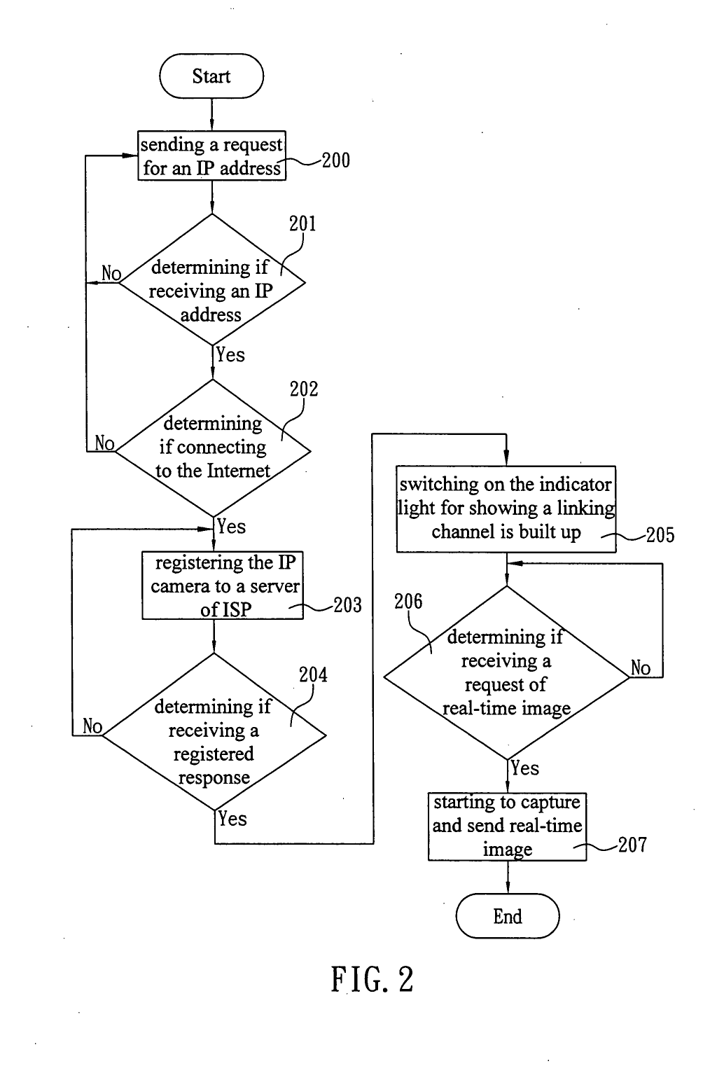

Still referring FIG. 1, in the preferred embodiment of the present invention, when the IP camera 10 is connected to the NAT router 12 via the signal cable 11, the IP camera 10 will execute the following processes, as shown in FIG. 2:

In step 200, searching the DHCP server 14 in a private network according to a DHCP protocol, and sending a request for an IP address;

In step 201, determining if the DHCP server 14 is found, and receiving an IP address from the DHCP server 14; if yes, go to step 202; otherwise, go back to the step 200;

In step 202, determining if the IP camera 10 can be linked to the Internet 13 according to the received IP address; if yes, go to step 203; otherwise, go back to the step 200;

In step 203, linking to a server 15 of an Internet service provider (ISP) via the Internet 13 according to the received IP address, and registering the IP address and a predetermined identification (ID) code of the IP camera 10 to the ISP server 15;

In step 204, determining if the ISP server 15 sends back a registered response; if yes, go to step 205; otherwise, go back to the step 203;

In step 205, switching on an indicator light 101 provided on the IP camera 10 for showing that a linking channel 16 between the IP camera 10 and the ISP server 15 is built up, so that other remote electronic devices 17 can log in the ISP server 15 to select/click the corresponding ID code of the IP camera 10, in order to download a real-time image captured by the IP camera 10 through the linking channel 16;

In step 206, determining if the IP camera 10 receives a request for transmitting the real-time image from the ISP server 15; if yes, go to step 207; otherwise, go back to the step 206; and

In step 207, starting to capture a real-time image of a scene 18, and immediately transmitting the captured real-time image to other remote electronic devices 17 through the linking channel 16 via the ISP server 15.

As a result, referring back FIG. 1, the remote electronic devices 17 can directly use the linking channel 16 built-up between the IP camera 10 and the ISP server 15, so as to prevent from passing through a firewall set by the NAT router 12 for the purpose of smoothly downloading the captured real-time image from the IP camera 10 and then showing the real-time image on a display 171 of the remote electronic device 17. As described above, a user can easily install and operate the IP camera 10 without executing any setting, only if connecting the IP camera 10 to the NAT router 12 in a plug-and-play manner. As a result, the purpose of transmitting the real-time image to other remote electronic device 17 via the Internet 13 will be carried out.

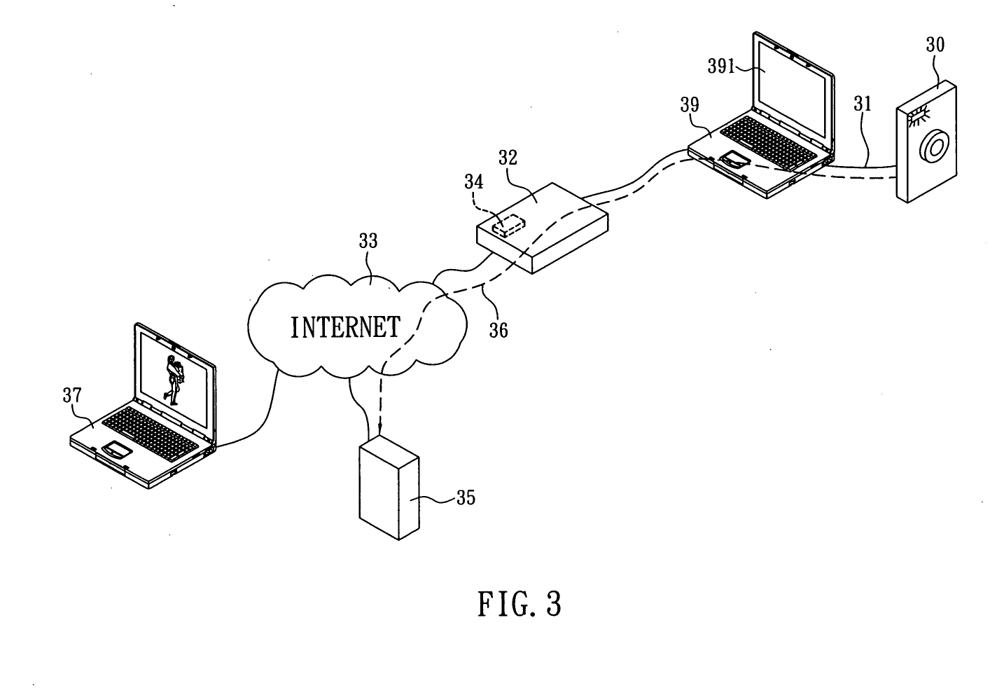

It should be noted that the IP camera 10 is directly connected to the NAT router 12 in the foregoing preferred embodiment of the present invention. However, the present invention is not limited to the foregoing connection manner. Referring now FIG. 3, in another preferred embodiment of the present invention, an IP camera 30 can be connected to a personal computer 39 via a signal cable 31, and the personal computer 39 is linked to the Internet 33 via a NAT router 32. When the IP camera 30 is connected to the personal computer 39, the steps similar to the foregoing preferred embodiment can be executed. The method in the preferred embodiment comprises the steps of: requesting an IP address from a DHCP server 34 in the NAT router 32 by the IP camera 30 according to a DHCP (Dynamic Host Configuration Protocol); automatically logging the IP camera 30 in a server 35 of an Internet service provider (ISP) linked to the Internet 33 after requesting the IP address and linking to the Internet 33; and building up a linking channel 36 between the IP camera 30 and the ISP server 35 after finishing logging. As a result, other remote electronic devices 37 (such as personal computer, PDA, and etc.) can download a real-time image captured by the IP camera 30 through the linking channel 36 via the Internet 33 after logging in the ISP server 35, in order to show the real-time image by the remote electronic devices 37. In the preferred embodiment of the present invention, the IP camera 30 is linked to the Internet 33 via the personal computer 39 and the NAT router 32. Thus, when the IP camera 30 registers its IP address and predetermined identification (ID) code to the ISP server 35, a driver program installed in the personal computer 39 will be started, in order to show a registration window on a display screen 391 of the personal computer 39. As a result, a user can select if the predetermined ID code should be changed or not, in order to ensure that the ID code registered in the ISP server 35 can represent the user of the IP camera 30, i.e. to increase the recognizability of the ID code of the IP camera 30.

It should be also noted that the IP camera is connected to the NAT router or the personal computer via the signal cable in a wired manner in the preferred embodiments of the present invention. However, the present invention is not limited to the foregoing connection manner. In alternatively preferred embodiment of the present invention, the IP camera can be connected to the NAT router or the personal computer in a wireless manner.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method of transmitting a real-time network image, applied to a network system comprising an IP camera, a NAT router, the Internet, and a server of an Internet service provider (ISP), wherein the NAT router and the ISP server are linked to the Internet, respectively, while the NAT router is provided with a DHCP server; when the IP camera is linked to the Internet via the NAT router, the IP camera executing the method comprising steps of:
searching the DHCP server in the NAT router according to a DHCP protocol, and sending a request for an IP address;
linking to the Internet according to the received IP address;
linking to the ISP server via the Internet according to the received IP address, and registering the IP address and a predetermined identification (ID) code of the IP camera to the ISP server; and
starting to capture a real-time image, and transmitting the captured real-time image to other remote electronic device through a linking channel built-up between the IP camera and the ISP server via the ISP server after determining that the ISP server sends back a registered response and receiving a request for transmitting the real-time image from the ISP server.

2. The method of claim 1, wherein the IP camera is provided with an indicator light, and wherein the indicator light is switched on for showing that the linking channel between the IP camera and the ISP server is built up, when the IP camera determines that the ISP server sends back the registered response.

3. A method of transmitting a real-time network image, applied to a network system comprising an IP camera, a personal computer, a NAT router, the Internet, and a server of an Internet service provider (ISP), wherein the NAT router is provided with a DHCP server, while the NAT router and the ISP server are linked to the Internet, respectively; when the IP camera is linked to the Internet via the personal computer and the NAT router in turn, the IP camera executing the method comprising steps of:
searching the DHCP server in the NAT router according to a DHCP protocol, and sending a request for an IP address;
linking to the Internet according to the received IP address;
linking to the ISP server via the Internet according to the received IP address, and registering the IP address and a predetermined identification (ID) code of the IP camera to the ISP server; and
starting to capture a real-time image, and transmitting the captured real-time image to other remote electronic device through a linking channel built-up between the IP camera and the ISP server via the ISP server after determining that the ISP server sends back a registered response and receiving a request for transmitting the real-time image from the ISP server.

4. The method of claim 3, wherein the IP camera is provided with an indicator light, and wherein the indicator light is switched on for showing that the linking channel between the IP camera and the ISP server is built up, when the IP camera determines that the ISP server sends back the registered response.

5. The method of claim 3, wherein when the IP camera registers the IP address and the predetermined ID code to the ISP server, starting a driver program installed in the personal computer to show a registration window on a display screen of the personal computer, so that a user can select if the predetermined ID code should be changed or not.

6. A method of transmitting a real-time network image, applied to an IP camera, comprising:
searching a DHCP server in a NAT router according to a DHCP protocol, and sending a request for an IP address;
linking to the Internet according to the received IP address;
linking to a server of an Internet service provider (ISP) via the Internet according to the received IP address, and registering the IP address and a predetermined identification (ID) code of the IP camera to the ISP server; and
starting to capture a real-time image, and transmitting the captured real-time image to other remote electronic devices through a linking channel built-up between the IP camera and the ISP server via the ISP server after determining that the ISP server sends back a registered response and receiving a request for transmitting the real-time image from the ISP server.

7. The method of claim 6, wherein the IP camera is provided with an indicator light, and wherein the indicator light is switched on for showing that the linking channel between the IP camera and the ISP server is built up, when the IP camera determines that the ISP server sends back the registered response.
